(19) United States
(12) Patent Application Publication
(10) Pub. No.: US 2012/0090792 A1
(43) Pub. Date: Apr. 19, 2012

(54) HANDICAP ENTRANCE CLIMATE CONTROL FLAPS

(76) Inventor: Michael Robert Moorman, Flint, MI (US)

(21) Appl. No.: 13/251,736

(22) Filed: Oct. 3, 2011

Related U.S. Application Data
(60) Provisional application No. 61/388,717, filed on Oct. 1, 2010.

(51) Int. Cl. B60J 9/02; B65G 69/28

(52) U.S. Cl. 160/107

(57) ABSTRACT

A plurality of flexible flaps are arranged in a row inward of a handicap entrance door of a bus. The flaps may be attached to the ceiling of the bus. The flaps may be similar to those seen in industrial freezer entrances. The entrance is permitted to remain effectively closed during the process of picking up or dropping off a handicapped student, except for the moment when the student passes through the flaps to enter the school bus, thus preventing uncomfortable temperature changes for other students in the bus.

This application claims priority to U.S. Provisional Application Ser. No. 61/388,717, filed Oct. 1, 2010.

### BACKGROUND

This disclosure generally relates generally to buses and more particularly to handicap entrances on buses.

Some school buses have large handicap entrances with an extendable ramp for assisting wheelchairs onto the bus. The doors to the handicap entrances must remain open during the extension of the ramp down onto the sidewalk, during the boarding process of the student, and during the subsequent folding process of the ramp back into the interior of the bus. In the winter months, especially in Northern areas, the extended period of time during which the large door is open to the elements causes the interior of bus to drop dramatically. The students already on the bus are thus subjected to repeated drops in temperature as each student boards the bus. Of course, the same disadvantages exist as the students are returned home each day.

### SUMMARY

The present invention aids in the retention of the interior cabin air temperature during boarding. In the disclosed embodiment, a plurality of flexible flaps are arranged in a row inward of the handicap entrance door. The flaps may be attached to the ceiling of a school bus. The flaps may be similar to those seen in industrial freezer entrances. The entrance is permitted to remain effectively closed during the process of picking up or dropping off a handicapped student, except for the moment when the student passes through the flaps to enter the school bus, thus preventing uncomfortable temperature changes for other students in the bus. These and other details of the disclosure are best described by the drawings included as well as by the detailed description below.

### BRIEF DESCRIPTION OF THE DRAWINGS

FIG. 1 shows a bus according to one embodiment of the present invention.

FIG. 2A is a section view of the handicap entrance of the bus of FIG. 1 with the ramp in the retracted, non-operational position.

FIG. 2B shows the handicap entrance of FIG. 2 with the ramp in the extended, operational position.

FIG. 3 shows the bus of FIG. 1 with some of the flaps pushed aside.

### DETAILED DESCRIPTION OF A PREFERRED EMBODIMENT

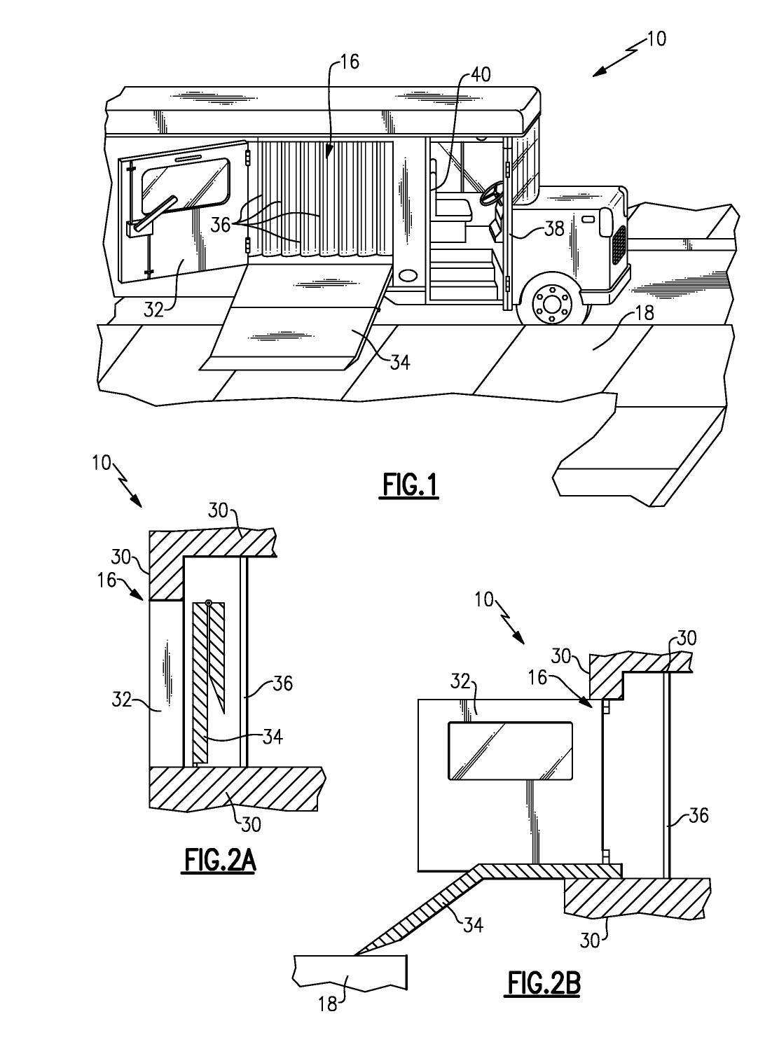

FIG. 1 shows the side of a traditional school bus 10 with a handicap entrance 16 on the side of the bus 10. The handicap entrance 16 consists of a ramp 34 which extends outward from the entrance 16 and rests on the sidewalk 18. The ramp 34 folds into the bus 10 when not in operation. A door 32 which closes when the bus is in operation conceals the folded ramp 34.

Inward from the ramp 34 is a set of flexible plastic flaps 36 which are attached to the ceiling of the bus 10 in order to prevent cold air from entering the bus 10 during the use of the ramp 34. The flaps 36 are slightly overlapped (or, alternatively, abutting) one another to provide a significant weather barrier when the door 32 is open. The flaps 36 are hanging, such that they can be pivoted and/or slid out of the way briefly when a student enters (or exits) via the handicap entrance 16. The flaps 36 may be clear or at least translucent (alternatively, the flaps 36 could be opaque).

The handicap entrance 16 is separate from a standard entrance 40 with stairs and a separate door 38 selectively covering the standard entrance 40. In this example, the handicap entrance 16 is rearward of the standard entrance 40.

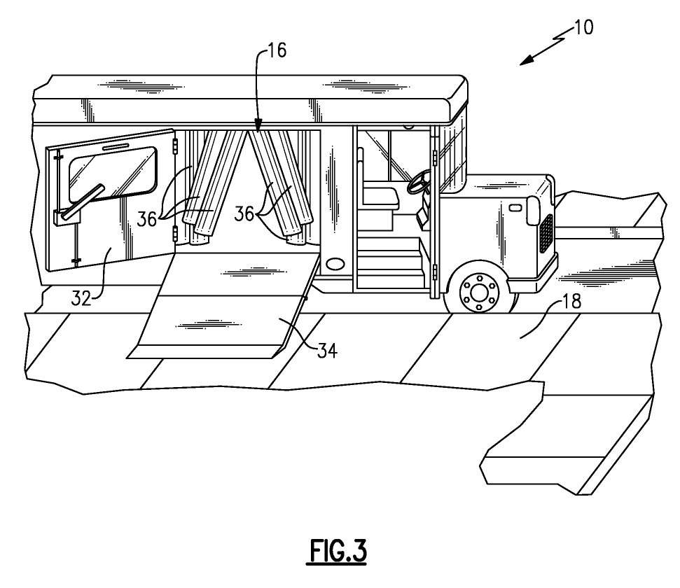

FIG. 2A shows a cross-sectional view of the handicap entrance 16 in the non-operational, retracted position. The door 32 is closed, the ramp 34 is folded into the interior of the bus walls 30, and the curtain of flaps 36 is inward of the door 32 and ramp 34 assembly.

FIG. 2B shows a cross-sectional view of the handicap entrance in the operational position. The door 32 is open, and extends outwardly from the bus walls 30. The ramp 34 is folded out and rests on the sidewalk 18, forming an inclined surface for the handicapped student (alternatively, the ramp 34 may be part of a lift to lift the student up to the height of the bus 10). The curtain of flaps 36 is attached to the ceiling of the bus and forms a barrier between the interior of the bus and the exterior while the door 32 is being opened, while the door is open, while the ramp 34 is being deployed, while the ramp 34 is deployed and while the student (or other person) boards the ramp 34 (or lift). Also, the flaps 36 provide the barrier after the student enters the bus 10 while the ramp 34 is being retracted and before the door 32 is closed.

As shown in FIG. 3, as the student (or other person) enters the bus 10 through the handicap entrance 16, the flaps 36 are pushed out of the way (laterally and/or inwardly). The flaps 36 pivot at their upper ends in a known manner and may also flex and bend to permit entrance to the bus 10. After the student passes, the flaps 36 return to their initial slightly-overlapped position as shown in FIG. 1, which provides a barrier until the door 32 is closed again.

Due to the presence of the curtain of flaps 36, heat is significantly less able to escape the passenger area of the bus during cold months and less able to enter the passenger area of the bus during hot months. This provides more constant, comfortable air quality for children riding the bus.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A handicap entrance for a bus comprising:
a door selectively covering an opening to the bus;
a retractable structure for facilitating entry onto the bus through the opening; and
a plurality of flaps inward of the door and the retractable structure, the plurality of flaps providing a substantial weather barrier, but permitting passage of a person between the flaps.

2. The handicap entrance of claim 1 wherein the retractable structure is a ramp.

3. The handicap entrance of claim 1 and a bus, wherein the handicap entrance is an entrance to the bus.

4. The handicap entrance and bus of claim 3 wherein the bus further includes a standard entrance having stairs separate from the handicap entrance.

5. The handicap entrance of claim 1 wherein the plurality of flaps are plastic.

6. The handicap entrance of claim 5 wherein the plurality of flaps are at least translucent.

7. The handicap entrance of claim 6 wherein the plurality of flaps are flexible.

8. The handicap entrance of claim 1 wherein the plurality of flaps are flexible.
